(19) United States
(12) Patent Application Publication
(10) Pub. No.: US 2016/0226034 A1
(43) Pub. Date: Aug. 4, 2016

(54) ENERGY STORAGE DEVICE

(71) Applicant: SAMSUNG SDI CO., LTD., Yongin-si (KR)

(72) Inventors: Shang Chul SEOK, Yongin-si (KR); Tae Jin KIM, Yongin-si (KR); Kyoung Hwan NOH, Yongin-si (KR)

(21) Appl. No.: 14/837,218

(22) Filed: Aug. 27, 2015

(30) Foreign Application Priority Data
Jan. 30, 2015 (KR) 10-2015-0015611

(51) Int. Cl. H01M 2/10; H01M 10/0525

(52) U.S. Cl. CPC H01M 2/1016; H01M 2/1022; H01M 2/1072; H01M 10/0525; H01M 2220/20; H01M 2220/30

(57) ABSTRACT

An energy storage device includes at least one battery pack including a plurality of unit batteries, a pack frame accommodating the plurality of unit batteries, and a rack housing accommodating the at least one battery pack with the pack frame, the rack housing including at least one support member supporting a side wall of the pack frame, wherein the plurality of unit batteries are arranged in an overlapping manner in a first direction, the at least one support member extending in a second direction perpendicular to the first direction and traversing the side wall of the pack frame.

### CROSS-REFERENCE TO RELATED APPLICATION

Korean Patent Application No. 10-2015-0015611, filed on Jan. 30, 2015, in the Korean Intellectual Property Office, and entitled: “Energy Storage Device,” is incorporated by reference herein in its entirety.

### BACKGROUND

1. Field

The present disclosure relates to an energy storage device, and more particularly, to an energy storage device having a secondary battery.

2. Description of the Related Art

In general, a secondary battery is a battery capable of being charged and discharged so as to be repeatedly used. The secondary battery may be charged using new and renewable energy, e.g., solar energy, as well as an existing electric power system, e.g., a power plant. The secondary battery is used as an energy source in automobiles or large facilities requiring power supply, as well as in electronic devices, e.g., a portable phone, a notebook computer, and a camcorder. An energy storage device is configured by connecting a plurality of secondary batteries in series or parallel for the purpose of high output or high capacity.

### SUMMARY

An energy storage device according to an embodiment includes at least one battery pack including a plurality of unit batteries, a pack frame accommodating the plurality of unit batteries, and a rack housing accommodating the at least one battery pack with the pack frame, the rack housing including at least one support member supporting a side wall of the pack frame, wherein the plurality of unit batteries are arranged in an overlapping manner in a first direction, the at least one support member extending in a second direction perpendicular to the first direction and traversing the side wall of the pack frame.

The plurality of unit batteries may be arranged in at least one column extending in the first direction. The at least one support member may include first and second support members coupled to the side walls of the pack frame from both ends of the column in a length direction.

The at least one support member may extend along an outer surface of the side wall.

The at least one support member may extend along a line corresponding to a height of a half of a height of the unit battery. Also, the at least one support member may extend to pass through the center of the side wall. The height of the side wall of the pack frame may be substantially similar to or the same as the height of the unit battery.

The at least one support member may be detachably coupled to the pack frame. Here, the pack frame and the at least one support member may be slidably coupled.

The pack frame may include at least one insertion recess provided on the side wall parallel to the second direction and allowing the support member to be inserted therein.

The insertion recess may extend in the second direction on an outer surface of the side wall.

The insertion recess may extend from one corner of the side wall to a corner of the opposite side.

### BRIEF DESCRIPTION OF THE DRAWINGS

Features will become apparent to those of ordinary skill in the art by describing in detail exemplary embodiments with reference to the attached drawings, in which:

FIG. 1 illustrates a perspective view of an energy storage device according to an embodiment;

FIG. 2 illustrates a partial, enlarged perspective view of a battery pack frame of FIG. 1;

FIG. 3 illustrates a perspective view of a pack frame of FIG. 2;

FIG. 4 illustrates a perspective view of a rack housing of FIG. 1;

FIG. 5 illustrates a schematic perspective view of an electrode assembly according to an embodiment;

FIG. 6 illustrates a view of the battery pack of FIG. 2 in the rack housing of FIG. 4;

FIG. 7 illustrates a schematic top of an expansive force acting on the battery pack of FIG. 1 in an arrow direction;

FIG. 8 illustrates a partial cross-sectional view of a pack frame in a rack housing according to a modified embodiment;

FIG. 9 illustrates a perspective view of a battery pack in a rack housing according to a modified embodiment; and

FIG. 10 illustrates a perspective view of a rack housing and a battery pack according to another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of elements and regions may be exaggerated for clarity of illustration. It will also be understood that when an element is referred to as being “on” another element or substrate, it can be directly on the other element or substrate, or intervening elements may also be present. In addition, it will also be understood that when an element is referred to as being “between” two elements, it can be the only element between the two elements, or one or more intervening elements may also be present. Further, when it is described that an element is “coupled” to another element, the element may be “directly coupled” to the other element or “electrically coupled” to the other element through a third element.

In the accompanying drawings, portions irrelevant to description of the example embodiments may be omitted for clarity. Like reference numerals refer to like elements throughout.

Hereinafter, embodiments will be described in detail with reference to the accompanying drawings such that they can be easily practiced by those skilled in the art. A secondary battery mentioned described hereinafter may be a battery having any configuration that can be charged and discharged.

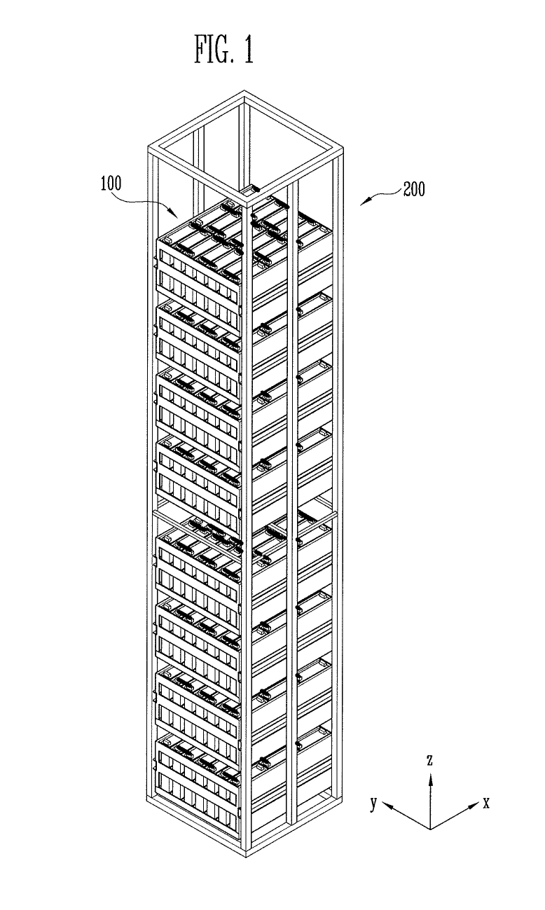

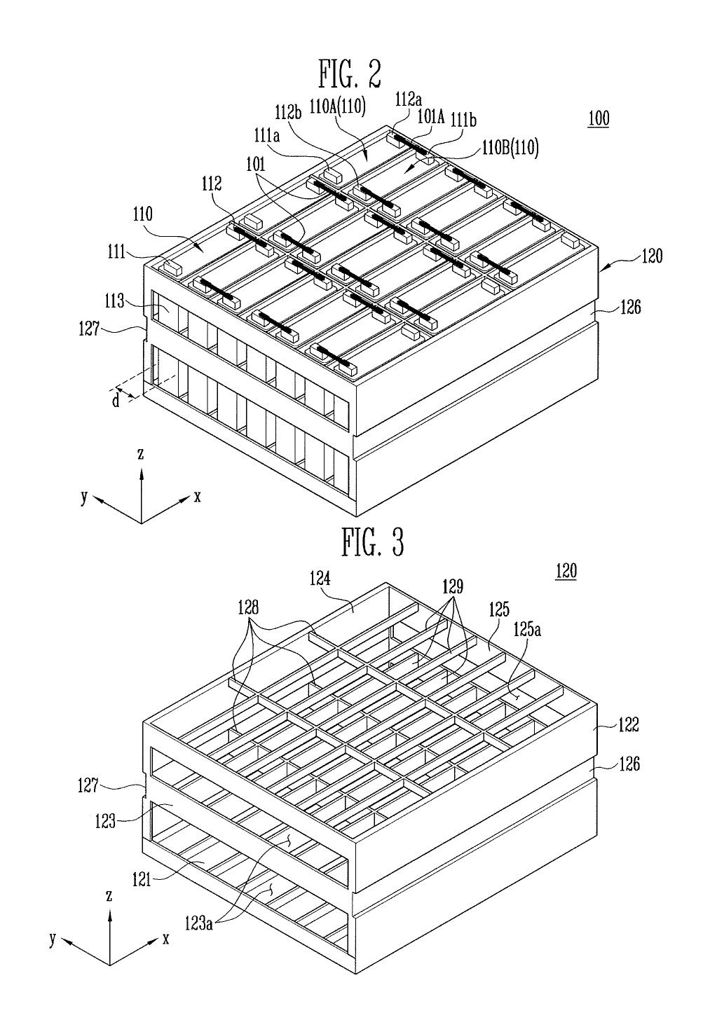

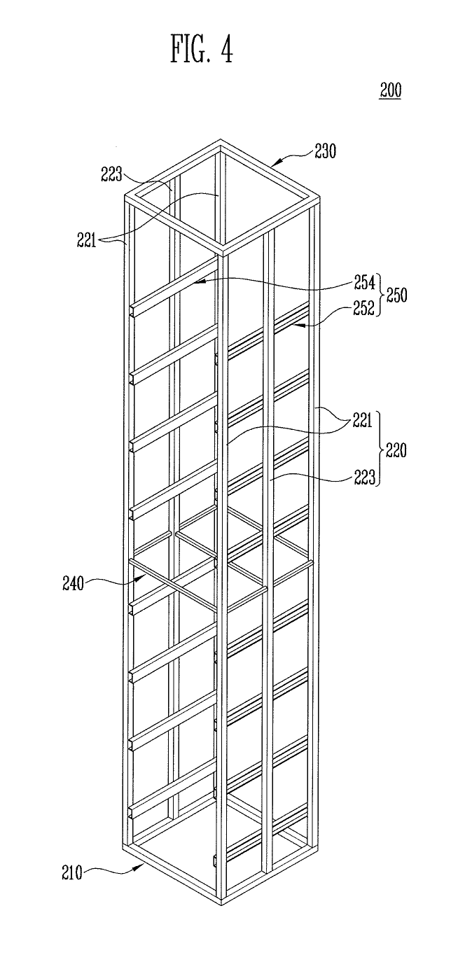

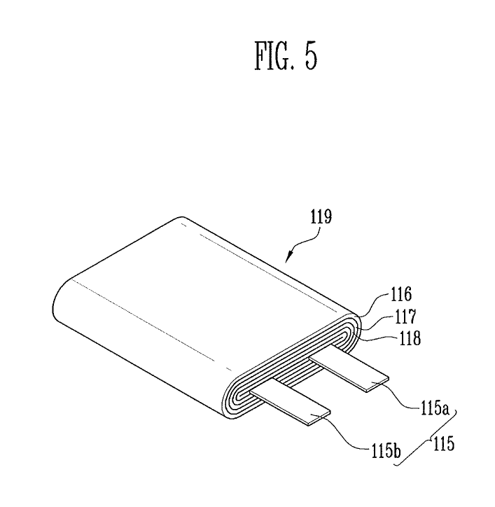

FIG. 1 is a perspective view of an energy storage device according to an embodiment, FIG. 2 is a perspective view of a battery pack frame of FIG. 1, FIG. 3 is a perspective view of a pack frame of FIG. 2, and FIG. 4 is a perspective view of a rack housing of FIG. 1. The energy storage device according to an embodiment will be described in detail with reference to FIGS. 1 through 4.

Referring to FIG. 1, an energy storage device according to an embodiment may include a battery pack 100 and a rack housing 200 for accommodating the battery pack 100. FIG. 1 illustrates eight (8) battery packs 100 accommodated in the rack housing 200, but embodiments are not limited thereto, i.e., embodiments may include an energy storage device in which one or more battery packs 100 are accommodated in the rack housing 200.

Referring to FIG. 2, the battery pack 100 is an assembly in which a plurality of unit batteries are connected in series or parallel, including a plurality of unit batteries 110, 110A, and 110B, and a pack frame 120 accommodating the unit batteries. It is noted that while FIG. 2 illustrates unit batteries that are connected in series, embodiments are not limited thereto, e.g., the unit batteries may be appropriately connected in series and/or in parallel to obtain intended capacity or output.

Further, although not shown, the battery pack 100 may further include a spacer between the unit batteries in order to insulate the unit batteries and provide a heat dissipation passage. Also, although not shown, the battery pack 100 may further include a control module for controlling charging and discharging of the unit batteries.

The unit battery is a secondary battery which can be charged or discharged. The unit battery is a battery in which an electrode assembly with a separator interposed between first and second electrodes is sealed together with an electrolyte in a case 113. The electrode assembly may be provided by stacking the first electrode, the separator, and the second electrode (hereinafter, referred to as a “stacked type”) or winding the stacked body (hereinafter, referred to as a “wound type”). The first and second electrodes have different polarities, e.g., the first electrode may be a positive electrode and the second electrode may be a negative electrode.

Also, the unit batteries 110, 110A, and 110B include first electrode terminals 111, 111a, and 111b, respectively, and second electrode terminals 112, 112a, and 112b, respectively. The first electrode terminals 111, 111a, and 111b, and the second electrode terminals 112, 112a, and 112b are electrically connected to the first electrode and the second electrode and exposed from the case.

FIG. 5 is a perspective view schematically illustrating a wound type electrode assembly as an exemplary electrode assembly 119. It is noted that FIG. 5 illustrates the wound type electrode assembly 119 only as an example, and embodiments may also include a stacked type electrode assembly.

Referring to FIG. 5, the electrode assembly 119 may be provided by sequentially stacking a first electrode plate 116, a separator 117, and a second electrode plate 118, followed by winding the same. The first electrode plate 116 serves as a first electrode, and the second electrode plate 118 serves as a second electrode. Also, the electrode assembly 119 may include an outwardly extending electrode tap 115, and the electrode tap 115 may include a first electrode tap 115a electrically connected to the first electrode plate 116 and a second electrode tap 115b electrically connected to the second electrode plate 118. The first and second electrode taps 115a and 115b may transmit electrochemical energy generated from the unit batteries to the outside.

Referring back to FIG. 2, the unit battery 110 may have an angular shape, e.g., a hexagonal shape, in which the case 113 has a predetermined thickness d. Thus, portions corresponding to the thickness of the unit battery 110 may be called edges, e.g., may include four sides, and two additional sides may be called both sides. That is, the both sides of the case 113 of the unit battery 110 may be two wide sidewalls, i.e., two sides of the case 113 that are parallel to a stacked plane in which the first electrode, the separator, and the second electrode of the electrode assembly are sequentially stacked. Further, the edges of the case 113 may be four narrow sidewalls, e.g., including top and bottom sides of the case 113. As such, the first electrode terminal 111 and the second electrode terminal 112 protrude from an edge of the unit battery 110, e.g., from a top side of the case 113. In other words, the first electrode terminal 111 and the second electrode terminal 112 protrude from one edge, i.e., side, among the four edges of the case 113.

For example, when the electrode assembly is a wound type electrode assembly, sides of the case 113 facing flat sides of the electrode assembly 119 are the both sides of the case 113, and sides facing rounded corners of the electrode assembly 119 may be the edges of the case 113. Also, when the electrode assembly is a stacked type electrode assembly, sides facing a stacked plane of the electrode assembly are the both sides of the case, and sides facing the sides providing a thickness or height of the stacked plane of the electrode assembly may be the edges of the case 113.

Also, although not shown, the unit battery 110 may have an exhaust for discharging gas between the first electrode terminal 111 and the second electrode terminal 112.

The unit battery 110 described above may be a battery having any configuration as long as it can react to an electrolyte to generate electrochemical energy. For example, the unit battery 110 may be a lithium polymer battery or a lithium ion battery. Specific components of the unit battery 110 are known, and thus, a detailed description thereof will be omitted.

As further illustrated in FIG. 2, the battery pack 100 may include a plurality of connection terminals 101 to connect the plurality of unit batteries 110 in series. For example, a first connection terminal 101A electrically connects the second electrode terminal 112a of a first unit battery 110A and the first electrode terminal 111b of a second unit battery 110B adjacent to the first unit battery 110A. In this manner, the plurality of unit batteries 110 may be connected in series. However, as described above, the present disclosure is not limited thereto, e.g., the plurality of unit batteries 110 may be connected in parallel or may be connected in series-parallel by the connection terminal 101.

For example, referring to FIG. 2, the plurality of unit batteries 110 may be received. e.g., arranged, in three columns in the pack frame 120. However, the number of columns is merely illustrative, and the unit batteries 110 may be arranged in an overlapping manner, e.g., with wide sides overlapping each other, in a first direction to provide at least one column. That is, the unit batteries 110 may be arranged in at least one column to be adjacent to each other along the first direction, such that the wide sides of the unit batteries 110 overlap each other. Here, the unit batteries 110 are arranged such that both sides thereof overlap each other. As described above, both sides of the unit battery 110 face the stacked plane of the electrode assembly. The first direction is a length direction of the column provided as the plurality of unit batteries 110 are arranged.

The pack frame 120 accommodates and protects the unit batteries 110, and is detachably fixed to the rack housing 200, such that the battery pack 120 may be received in the rack housing 200. As illustrated in FIG. 3, the pack frame 120 may include a bottom surface 121, a plurality of side walls 122, 123, 124, and 125 extending upwardly from edges of the bottom surface 121 to provide the sides of the pack frame 120, and a plurality of separation walls 128 and 129 provided between the side walls.

The pack frame 120 includes a space surrounded by the bottom surface 121 and the plurality of side walls, and accommodates the plurality of unit batteries 110 in the space. The plurality of side walls includes a first side wall 122, a second side wall 124, a third side wall 123, and a fourth side wall 125. The first and second side walls 122 and 124 are side walls facing wide sides of the unit battery 100, i.e., the first and second side walls 122 and 124a face the both sides of the case 113, and the third and fourth side walls 123 and 125 are side walls facing narrow sides of the unit battery 110, i.e., the edges of the case 113.

Insertion recesses 126 and 127 supported by the rack housing 200 are provided on the first and second side walls 122 and 124. A first insertion recess 126 provided on the first side wall 122 and a second insertion recess 127 provided on the second side wall 124 have the same shape. Hereinafter, although only the first insertion recess 126 is described, the described features may also be applied to the second insertion recess 127.

As illustrated in FIG. 3, the first insertion recess 126 extends across an outer surface of the first side wall 122. Since the first and second side walls 122 and 124 are parallel to both sides of the unit battery 110, the first and second insertion recesses 126 and 127 extend in a second direction perpendicular to the first direction, e.g., along the x-axis. In other words, the first and second insertion recesses 126 and 127 extend to be perpendicular to a length direction of the column provided as the unit batteries 110 are arranged.

The first and second insertion recesses 126 and 127 extend in a substantially central line of the unit battery cells 110, e.g., each of the first and second insertion recesses 126 and 127 may be in respective centers of the first and second side walls 122 and 124 along the z-axis. The central line corresponds to a line dividing each of the both sides of the unit batteries into two halves, and the substantially central line is a line passing through a portion to which expansive force concentratedly is applied from both sides of the unit batteries 110. However, the positions of the first and second insertion recesses 126 and 127 are not limited thereto. e.g., the first and second insertion recesses 126 and 127 may be provided to extend to be parallel to the central line and may be provided above or below the central line.

Also, in the present exemplary embodiment, one first insertion recess 126 and one second insertion recess 127 are provided. However, embodiments are not limited thereto. For example, a pair of first insertion recesses may extend to be parallel to each other and parallel to the central line and may be disposed above and below the central line interposed therebetween. Similarly, the second insertion recess may also be provided as a pair. In this manner, the disposition and number of the insertion recesses may be modified according to the positions in which the support member is coupled to the first and second side walls and the number of the support members in order to suppress swelling of the unit batteries.

As illustrated in FIG. 3, the first insertion recess 126 may be provided to have a predetermined depth on the outer surface of the first side wall 122, and is open outwardly from the first side wall. The first insertion recess 126 extends to both corners where the first side 122 wall meets the third and fourth side walls 123 and 125. Similarly, the second insertion recess 127 extends to both corners where the second side 124 wall meets the third and fourth side walls 123 and 125. That is, each of the first and second insertion recesses 126 and 127 extends continuously along the entire first and second side wall 122 and 124, respectively. Thus, both ends of the first and second insertion recesses 126 and 127 provide an opening in the corners of the third and fourth side walls 123 and 125.

Through holes 123a and 125a are provided in the third and fourth side walls 123 and 125 to cool the unit batteries 110, respectively. For example, as illustrated in FIG. 3, each of the through holes 123a and 125a extends continuously along the entire third and fourth side wall 123 and 125, respectively.

As further illustrated in FIG. 3, the plurality of separation walls 128 and 129 separate the space of the pack frame 120 into a plurality of spaces to allow the unit batteries 110 to be accommodated in each space. Here, the plurality of separation walls 128 and 129 are provided to be spaced apart in a vertical direction such that the spaces communicate with each other, e.g., each one of the plurality of separation walls 128 and 129 includes at least two portions spaced apart from each other along the z-axis. By the plurality of separation walls 128 and 129, the unit batteries 110 are stably accommodated, a cooling passage is provided, and the spaces of the pack frame 120 are firmly maintained.

In detail, the plurality of separation walls 128 and 129 include a plurality of first separation walls 128 extending in the first direction, e.g., along the y-axis, and a plurality of second separation walls 129 extending in the second direction, e.g., along the x-axis. Also, the first separation walls 128 extend from an inner surface of any one side wall among the first and second side walls 122 and 124 facing each other to an inner surface of the other side wall. The second separation walls 129 extend from an inner surface of any one side wall among the third and fourth side walls 123 and 125 facing each other to an inner surface of the other side wall.

The plurality of first separation walls 128 are members separating the spaces in the pack frame 120, such that the plurality of unit batteries 110 are arranged in the first direction. For example, a first pair of first separation walls 128 may be fixed to be spaced apart from one another in a horizontal direction, e.g., along the x-axis, and abut an opening provided in an upper portion of the pack frame 120, e.g., uppermost surfaces (edges) of the first separation walls 128 may be level with uppermost surfaces (edges) of the first and second side walls 122 and 124. Similarly, a second pair of the first separation walls 128 may be fixed to be spaced apart from one another in the horizontal direction and abut on a bottom surface of the pack frame 120, while being spaced apart from the first pair of first separation walls 128 along the z-axis. Here, the horizontal direction refers to a direction parallel to the bottom surface. The first and second pairs of the first separation walls 128 are provided above and below, respectively, separating the spaces of the pack frame 120 into three rows along the y-axis. However, as described above, the plurality of unit batteries 110 may be provided in any suitable number of columns, e.g., a first separation wall 128 is not provided when the plurality of unit batteries 110 is arranged as a single column.

The plurality of second separation walls 129 separate the spaces of each column in the pack frame 120 by a number of unit batteries provided in the column. Like the first separation walls 128, a first plurality of second separation walls 129 may be provided to abut the upper opening of the pack frame 120, and a second plurality of second separation walls 129 are provided to abut the bottom surface of the pack frame 120. The second separation walls 129 are spaced apart from one another along the y-axis, such that a space sufficient for one unit battery 100 to be accommodated therein is secured.

The shape and disposition of the separation walls 128 and 129 are not limited thereto. Further, if necessary, the separation walls 128 and 129 may be omitted, or the separation walls 128 and 129 may be modified such that a plurality of unit batteries 110 are provided in one space.

Referring to FIG. 4, the rack housing 200 may be a cabinet accommodating a plurality of battery packs 100, e.g., eight battery packs 100, within a plurality of corresponding pack frames 120. Further, the rack housing 200 may include a plurality of rack frame members and a plurality of support members 250 fixed to the rack frame members to support side walls of the pack frames 120.

In detail, as illustrated in FIG. 4, the plurality of rack frame members may include a first frame 210 providing a bottom frame of the rack housing 200, a second frame 220 extending in a vertical direction, e.g., along the z-axis, to provide a side frame of the rack housing 200, and a third frame 230 providing an upper frame of the rack housing 200. Also, the plurality of rack frame members may further include a fourth frame 240 fixed to the second frame 220 between the first frame 210 and the third frame 230 to firmly support a middle portion of the rack housing 200. Here, the fourth frame 240 may have the same shape as that of the first and third frames 210 and 230.

As illustrated in FIG. 4, the first frame 210 and the third frame 230 have the same shape and are provided on upper and lower portions of the rack housing 200, respectively. The first and third frames 210 and 230 are frames having, e.g., rectangular, edges and middle portions thereof are open. However, the present disclosure is not limited thereto, e.g., the first and third frames 210 and 230 may have any configuration as long as it has functions of the upper frame and the lower surface of the rack housing 200.

The second frame 220 may include a plurality of pillar members extending from the first frame 210 to the third frame 230. The plurality of pillar members may include four corner pillars 221 extending to corresponding corners of the third frame 230 from the corners of the first frame 210, and a pair of intermediate pillars 223 extending from the first frame 210 to the third frame 230, and disposed between two corner pillars 221. The pair of intermediate pillars 223 are provided on a side where the first and second side walls 122 and 124 of the battery pack are disposed.

The plurality of support members 250 are on the frame members of the rack housing 200, e.g., the plurality of support members 250 may be on inner surfaces of the frame members, to support side walls of the battery packs 100. That is, the battery packs 100 are fixed to the rack housing 200 via the support members 250, e.g., fixed to the second frame 220 of the rack housing 200 via the support members 250. A first side of the support member 250 facing the battery pack 100 is coupled to the side wall of the battery pack 100, and a second (opposite) side of the support member 250 is fixed to the second frame.

The support member 250 is a planar member extending in the second direction, e.g., along the x-axis, and edges thereof in a width direction are bent in the first direction. However, the shape of the support member is not limited thereto, e.g., the support member may have any shape extending in the second direction.

The support member 250 includes a first support member 252 supporting the first side wall 122 of the battery pack 100 and a second support member 254 supporting the second side wall 124 of the battery pack 100. The first and second support members 252 and 254 support across the outer surfaces of the first and second side walls 122 and 124 in the second direction, and are disposed in portions corresponding to central lines of both sides of the unit battery 110. In detail, the first support member 252 is inserted from an outer surface of the first side wall 122 to the first insertion recess 126 to support the first side wall 122. Similarly, the second support member 254 is inserted from an outer surface of the second side wall 124 to the second insertion recess 127 to support the second side wall 124.

The position in which the support member 250 is inserted into a side wall of the battery pack 100 is not limited thereto and may be modified as described above in relation to the insertion recess. For example, the first and second support members 252 and 254 may support across the first and second side walls 122 and 124 in the second direction, respectively, and may be disposed to slightly deviate from the central lines of both sides of the unit battery 110. Also, in the present embodiment, one first support member 250 is coupled to the first side wall 122 and one second support member 254 is coupled to the second side wall 124. However, embodiments are not limited thereto, e.g., a pair of first support members 252 may be disposed on the first side wall 122 and slightly spaced apart from a central line in opposite directions, and a pair of second support members 254 may be disposed on the second side wall 124 and slightly spaced apart from a central line in opposite directions.

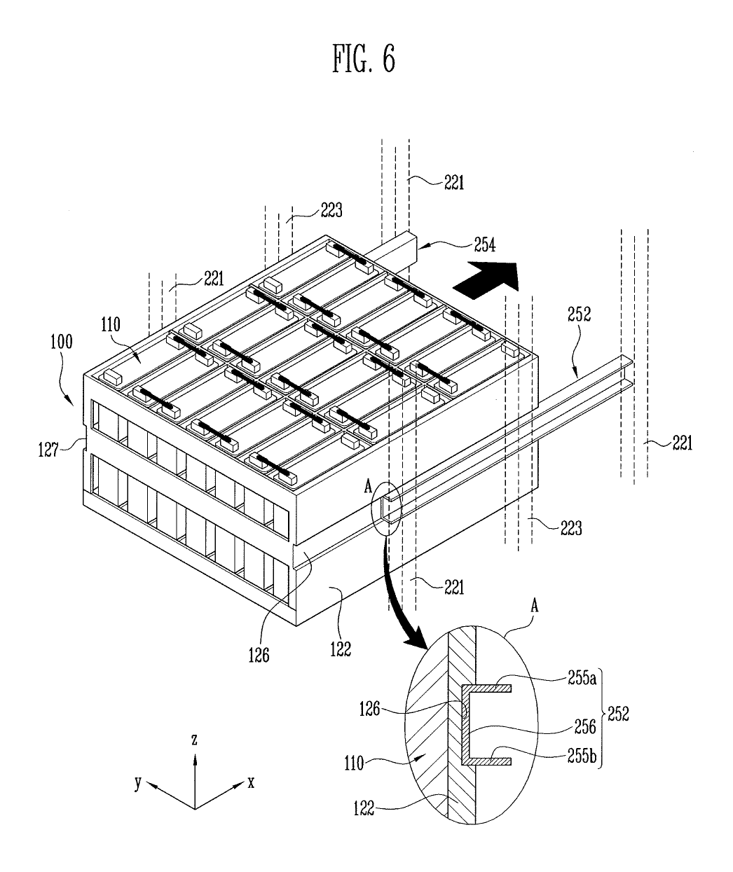

FIG. 6 is a view illustrating a state in which the battery pack 100 is installed in the rack housing 200. A specific configuration of the support member 250 and a structure in which the battery pack 100 is installed in the rack housing 200 will be described in detail with reference to FIG. 6.

Referring to FIG. 6, the first support member 252 includes a planar body 256 inserted into the first insertion recess 126 and a pair of ribs 255a and 255b bent from respective edges of the body 256 outwardly and extending in the first direction. The second support member 254 has the same shape as that of the first support member 252, and is inserted into the second insertion recess 127. Hereinafter, the first support member 252 will be described in detail and this may also be applied in the same manner to the second support member 254.

The body 256 is a planar member extending in the second direction, and has the same width as that of the first insertion recess 126 along the z-axis. The pair of ribs 255a and 255b are bent in the first direction, e.g., along the y-axis, from both edges of the body 256 in the width direction. The pair of ribs 255a and 255b extend outwardly, e.g., along the y-axis, and have the same thickness as that of the body. The pair of ribs 255a and 255b are fixed to the inner side of the second frame 220, such that a portion of each of the ribs 255a and 255b has a width along the y-axis that equals at least the depth of the first insertion recess 126 and protrudes from the second frame 220. In other words, as illustrated in FIG. 6, each of the ribs 255a and 255b extends from the inner side of the second frame 220 toward the interior of the rack housing 200 along the y-axis, such that both the ribs 255a and 255b may be inserted into a same first insertion recess 126 of the battery pack 100. The ribs 255a and 255b are connected by the body 256 along the z-axis, such that the body 256 is inserted into the same first insertion recess 126 with the ribs 255a and 255b. The pair of ribs 255a and 255b may be fixed to the second frame 220 by a fastening member, e.g., a bolt, or may be fixed to the second frame 220, e.g., by welding, but the present disclosure is not limited thereto.

The first insertion recess 126 is a concave recess including three sides and having a predetermined depth, and a vertical cross-section thereof has a C shape (see portion A in FIG. 6). The vertical cross-section refers to a cross-section perpendicular to the extending direction of the first insertion recess 126. The shape of the vertical cross-section is provided such that the body 256 of the first support member 252 and a portion of the rib extending from the body 256 fit to the first insertion recess 126. However, the shape of the vertical cross-section of the first insertion recess 126 is not limited thereto, and may have any shape in which the first support member 252 is slidably inserted therein. Similarly, the second insertion recess 127 may also have any shape in which the second support member 254 is slidably inserted therein.

As illustrated in FIG. 6, the first and second support members 252 and 254 are slidably inserted into the first and second insertion recesses 126 and 127, respectively, through the opening provided in the corner of the fourth side wall 125. In detail, for example, in case of the first support member 252, the body 256 is in contact with a bottom surface of the insertion recess 126, and the pair of ribs 255a and 255b are in contact with the other remaining two sides of the insertion recess 126. The first and second support members 252 and 254 are inserted, e.g., pushed, until end portions thereof pass through, e.g., align with, the opening provided in the corner of the third side wall 123.

Thus, when the battery pack 100 is completely received in the rack housing 200, the first support member 252 extends from one corner of the first side wall 122 to the opposite corner thereof along the central line of the unit battery 110 across the outer surface of the first side wall 122. Similarly, the second support member 254 extends from one corner of the second side wall 124 to the opposite corner thereof along the central line of the unit battery 110 across the outer surface of the second side wall 124. In this manner, the first and second support members 252 and 254 are coupled to the side walls of the battery pack 110 to support the side walls. Since the plurality of support members 250 are slidably coupled to the first and second insertion recesses 126 and 127, the battery pack 100 may be separated from the plurality of support members 250 in a sliding manner.

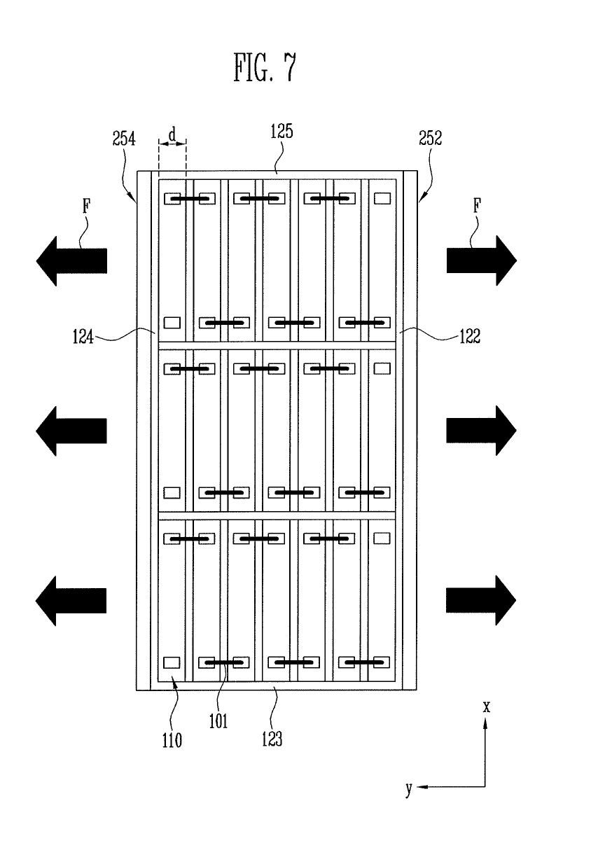

FIG. 7 is a top view illustrating a shape in which expansive force acts on the battery pack 100 in the arrow direction. A configuration for preventing swelling of the battery pack 100 installed in the rack housing 200 will be described in detail.

Referring to FIG. 7, when the unit battery 110 swells, expansive force acts on the outer side of the unit battery 100 in a direction (F) perpendicular, e.g., normal, to both sides of the unit battery 110. Here, the direction perpendicular to both sides of the unit battery 110 is the same as the first direction, e.g., y-axis in FIG. 2. Thus, it may be considered that the expansive force F acts in parallel to the first direction and perpendicularly to the second direction. However, as the first and second support members 252 and 254 extend in the second direction, i.e., along the central line of the unit battery 110 to traverse the first side wall and the second side wall 122 and 124, the unit battery 110 is restrained from expanding in the arrow direction (F) despite the expansive force.

The effect of the foregoing aspect will be described by using deformation as an example. For example, deformation, e.g., a degree of deformation due to the expansive force in the direction F, of a pack frame before being installed in the rack housing 200 ranged from about 0.8 mm to 1.2 mm. After installation of the pack frame in the rack housing 200, followed by application of a same expansive force in the direction F on the pack frame, deformation was measured in a range from about 0.2 mm to 0.8 mm. Also, in a state in which the pack frame is installed, a degree of deformation of the vicinity of the support members and around the support members of the rack housing due to the expansive force F was measured to range from about 0.2 mm to 0.8 mm.

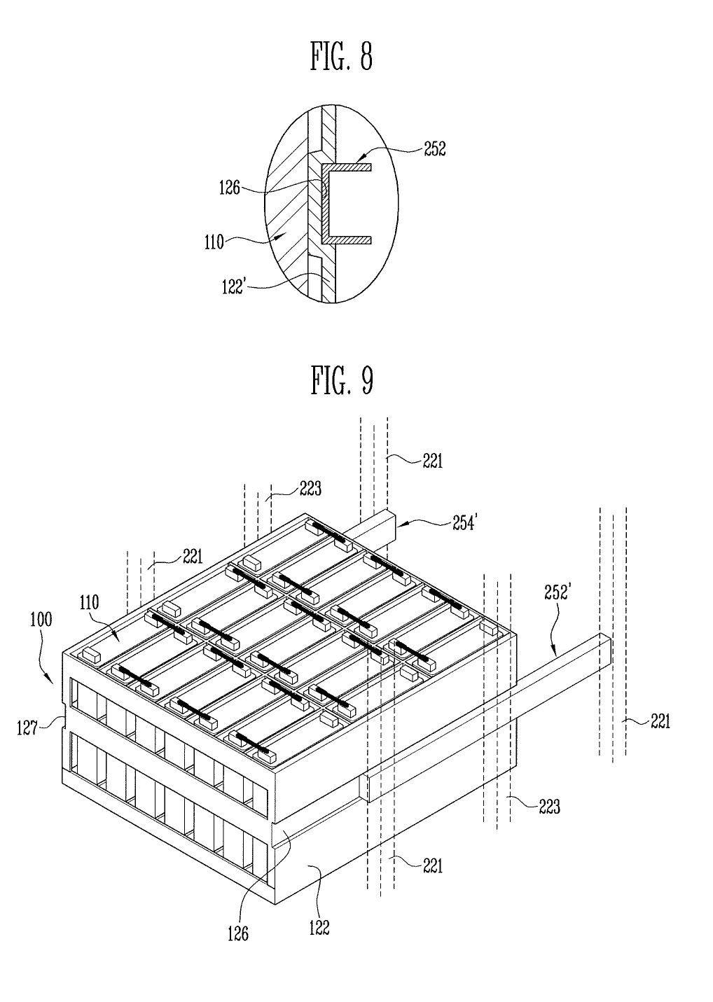

FIG. 8 is a partial cross-sectional view illustrating a state in which a modified embodiment of a pack frame is installed in the rack housing 200. The portion illustrated in FIG. 8 is a cross-sectional view of corresponding to the portion A of FIG. 6.

Referring to FIG. 8, the insertion recess 126 provided on a first side wall 122′ of a pack frame according to the modified embodiment is provided through pressing. Thus, while the shape of the insertion recess 126 is the same as that described previously with reference to FIG. 3, but the shape of the cross-section of the first side wall 122′ is different from the first side wall 122 in FIG. 3. That is, in the case of the embodiment of FIG. 6, a thickness of a portion of the first side wall 122 where the first insertion recess 126 is provided is smaller than the thickness of the other remaining portion. However, in the embodiment of FIG. 8, a portion of the first side wall 122′ where the first insertion recess 126 is provided has the same thickness as that of the other remaining portion. Other portions are the same as those of the embodiment described above. Similarly, the second insertion recess of the second side wall may also be provided through pressing.

FIG. 9 is a perspective view illustrating a shape in which the battery pack 100 is installed in a rack housing according to another embodiment. In the embodiment of FIG. 9, a shape of a cross-section of a plurality of support members is different, as compared to components described above with reference to FIGS. 1 through 8.

Referring to FIG. 9, a plurality of support members 252′ and 254′ are provided as members having a body with a quadrangular bar shape extending in the second direction. That is, a vertical cross-section of the plurality of support members 252′ and 254′ has a rectangular shape. A shape of the plane where the support members 252′ and 254′ are in contact with the insertion recess is the same as that of the embodiment described above. The plurality of support members are slidably inserted into the insertion recesses 126 and 127, respectively, as described above. The other portions are the same as those described above, and thus, a detailed description thereof will be omitted.

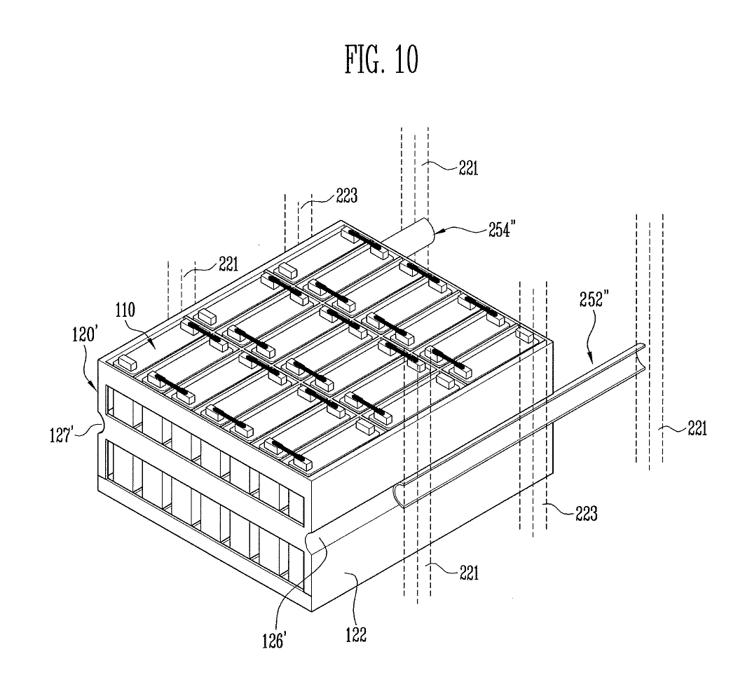

FIG. 10 is a view illustrating a modified embodiment in which a shape of an insertion recess and a shape of a plurality of support members 252″ and 254″ is modified. Referring to FIG. 10, an insertion recess 126′ provided on the first side wall 122 is provided as a single concave curved surface. The insertion recess 126′ extends from one corner of the first side wall 122 to the corner of the other side in the second direction and the curved surface faces the first support member 252″. The insertion recess 126′ extends along a central line of the side of the unit battery 110. An insertion recess 127′ is provided on the second side wall 125 and has the same shape. The insertion recesses 126′ and 127′ according to the modified embodiment have the same function and effect as those of the embodiment described above, except that they are provided as curved surfaces, and a further detailed description thereof will be omitted.

The first support member 252″ is provided as a body having a curved surface provided to be convex with the same curvature as that of the curved surface of the insertion recess 126′. In FIG. 10, the first support member is illustrated as a member having a plate shape, but the embodiments are not limited thereto and the first support member may have a shape of a pipe or a circular bar shape having an outer diameter with the same curvature as that of the curved surface of the insertion recess. The second support member 254″ may be provided in the same manner as that of the first support member and inserted into the insertion recess 127′. The other components are the same as those of the embodiment described above, and thus, a detailed description thereof will be omitted.

By way of summation and review, according to embodiments, an energy storage device includes a rack housing capable of firmly supporting a battery pack. That is, since the support member supports the side wall of the battery pack in the second direction across the side wall, expansive force acting on the battery pack in the first direction may be restrained.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An energy storage device, comprising:
at least one battery pack including a plurality of unit batteries;
a pack frame accommodating the plurality of unit batteries; and
a rack housing accommodating the at least one battery pack with the pack frame, the rack housing including at least one support member supporting a side wall of the pack frame,
wherein the plurality of unit batteries are arranged in an overlapping manner in a first direction, the at least one support member extending in a second direction perpendicular to the first direction and traversing the side wall of the pack frame.

2. The energy storage device as claimed in claim 1, wherein:
the plurality of unit batteries is arranged in at least one column extending in the first direction, and
the at least one support member includes first and second support members respectively coupled to first and second side walls of the pack frame, the first and second side walls being respectively disposed at first and second ends of the column in a length direction.

3. The energy storage device as claimed in claim 1, wherein the at least one support member extends along an outer surface of the side wall of the pack frame.

4. The energy storage device as claimed in claim 3, wherein the at least one support member extends along a line corresponding to a height of a substantially half of a height of the unit battery.

5. The energy storage device as claimed in claim 1, wherein the at least one support member is detachably coupled to the pack frame.

6. The energy storage device as claimed in claim 5, wherein the at least one support member is slidable into the pack frame.

7. The energy storage device as claimed in claim 1, wherein the pack frame includes at least one insertion recess on the side wall, the side wall extending in the second direction, and the support member being inserted into the insertion recess.

8. The energy storage device as claimed in claim 7, wherein the insertion recess extends in the second direction on an outer surface of the side wall.

9. The energy storage device as claimed in claim 7, wherein the insertion recess extends from a first edge of the side wall to a second edge of the side wall, the second edge being opposite to the first edge.
